(19) United States
(12) Patent Application Publication
(10) Pub. No.: US 2011/0174074 A1
(43) Pub. Date: Jul. 21, 2011

(54) FRAMED TRANSDUCER DEVICE

(75) Inventors: Gary G. Li, Gilbert, AZ (US); Todd F. Miller, Scottsdale, AZ (US); Lisa Z. Zhang, Gilbert, AZ (US)

(73) Assignee: FREESCALE SEMICONDUCTOR, INC., Austin, TX (US)

(21) Appl. No.: 12/688,560

(22) Filed: Jan. 15, 2010

(51) Int. Cl. G01C 19/56

(52) U.S. Cl. 73/504.14

(57) ABSTRACT

A MEMS device (20) includes a substrate (22), a proof mass (28), and a frame structure (30) laterally spaced apart from the proof mass (28). Compliant members (36) are coupled to the proof mass (28) and the frame structure (30) to retain the proof mass (28) suspended above the surface (26) of the substrate (22) without directly coupling the proof mass (28) to the substrate (22). Anchors (32) suspend the frame structure (30) above the surface (26) of the substrate (22) without directly coupling the structure (30) to the substrate (22), and retain the structure (30) immovable relative to the substrate (22) in a sense direction (42). The compliant members (36) enable movement of the proof mass (28) in the sense direction (42). Movable fingers (38) extending from the proof mass (28) are disposed between fixed fingers (46) extending from the frame structure (30) to form a differential capacitive structure.

### TECHNICAL FIELD OF THE INVENTION

The present invention relates generally to transducer devices. More specifically, the present invention relates to a microelectromechanical systems (MEMS) transducer device with reduced mismatch, or offset, caused by thermal mechanical stress.

### BACKGROUND OF THE INVENTION

Microelectromechanical Systems (MEMS) transducer devices are widely used in applications such as automotive, inertial guidance systems, household appliances, protection systems for a variety of devices, and many other industrial, scientific, and engineering systems. Such MEMS devices are used to sense a physical condition such as acceleration, pressure, or temperature, and to provide an electrical signal representative of the sensed physical condition. Capacitive-sensing MEMS sensor designs are highly desirable for operation in high gravity environments and in miniaturized devices, and due to their relatively low cost.

One particular type of MEMS sensor used in various applications is an inertial sensor, such as an accelerometer. Typically, a MEMS accelerometer includes, among other component parts, a movable element, also referred to as a proof mass. The proof mass is suspended above and anchored to an underlying substrate by one or more suspension springs. The proof mass typically includes a number of movable fingers, also referred to as movable electrodes. Fixed fingers which may be some combination of sense electrodes and/or actuator electrodes, are positioned between the movable electrodes, and are formed on or otherwise attached to the underlying substrate. Fixed fingers are referred to variously as immovable fingers, fixed electrodes, or immovable electrodes. The proof mass moves when the accelerometer experiences acceleration in a sense direction that is substantially parallel to a plane of the substrate. Movement of the proof mass alters capacitances between the movable and the fixed electrodes, and these capacitances can be used to determine differential or relative capacitance indicative of the acceleration.

In existing MEMS transducer designs, the fixed electrodes are directly anchored to substrate. Yet the movable electrodes are attached to the proof mass and the proof mass is anchored to the substrate via the suspension springs. As temperature varies from low to high for example, both the movable electrodes (attached to proof mass) and the fixed electrodes (directly anchored to substrate) change their positions relative to one another. In general, this change in the relative positions of the movable and fixed electrodes (i.e., the change in the gap between the movable and fixed electrodes) is not uniform over the temperature variations. This non-uniform change results in an undesirably high thermal coefficient of offset (TCO). Accordingly, TCO is a signal not related to the input signal (acceleration, for example), but is related instead to mismatch, or offset, caused by thermal mechanical stresses. A high TCO indicates correspondingly high thermally induced stress, and this high thermally induced stress adversely affects the output performance of the MEMS device.

The fabrication and packaging of MEMS device applications often use various materials with dissimilar coefficients of thermal expansion. As the various materials expand and contract at different rates in the presence of temperature changes, the active transducer layer of the MEMS device may experience stretching, bending, warping and other deformations due to the different dimensional changes of the different materials. Thus, significant thermal stress, i.e., an undesirably high TCO, often develops during manufacture or operation further adversely affecting the output performance of the MEMS device.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a top view of a microelectromechanical systems (MEMS) device in accordance with an embodiment of the invention;

FIG. 2 shows a side view of the MEMS device of FIG. 1 along section line 2-2;

FIG. 3 shows a top view of a MEMS device in accordance with another embodiment of the invention;

FIG. 4 shows a top view of a MEMS device in accordance with another embodiment of the invention;

FIG. 5 shows a side view of the MEMS device of FIG. 4 along section line 5-5; and

FIG. 6 shows a top view of a MEMS device in accordance with yet another embodiment of the invention.

### DETAILED DESCRIPTION

Embodiments of the invention entail a microelectromechanical systems (MEMS) transducer, referred to herein as a MEMS device, in which the MEMS device is largely isolated from the underlying substrate. This isolation is achieved by significantly reducing the connection of both movable and fixed elements to the substrate, relative to prior art devices, and by locating these connections within close proximity of an axis of symmetry of the MEMS device.

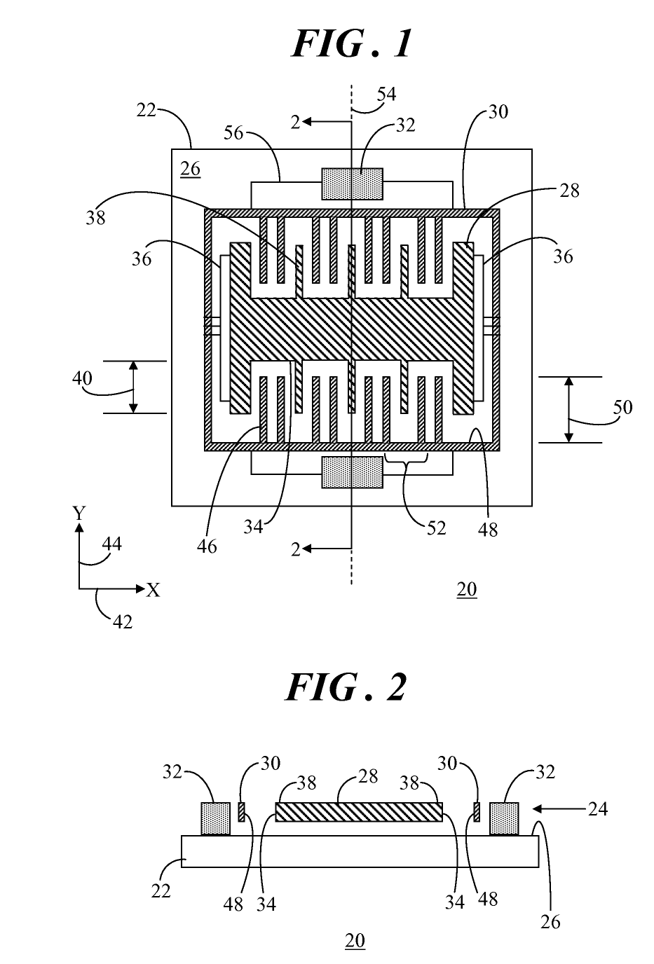

Referring now to FIGS. 1-2, FIG. 1 schematically shows a top view of a MEMS device 20 in accordance with an embodiment of the invention. FIG. 2 shows a side view of MEMS device 20 along section line 2-2 in FIG. 1. FIGS. 1 and 2 are illustrated using various shading and/or hatching to distinguish the different elements produced within the structural layers of MEMS device 20, as will be discussed below. These different elements within the structural layers may be produced utilizing current and upcoming surface micromachining techniques of depositing, patterning, etching, and so forth. Accordingly, although different shading and/or hatching is utilized in the illustrations, the different elements within the structural layers are typically formed out of the same material, such as polysilicon, single crystal silicon, and the like.

The elements of MEMS device 20 (discussed below) may be described variously as being “attached to,” “attached with,” “coupled to,” “fixed to,” or “interconnected with,” other elements of MEMS device 20. It should be understood that these terms refer to the direct or indirect physical connections of particular elements of MEMS device 20 that occur during their formation through patterning and etching processes of MEMS fabrication. However, the terms “direct” or “directly” preceding any of the above terms refers expressly to the physical connection of particular elements of MEMS device 20 with no additional intervening elements.

MEMS device 20 includes a substrate 22 and a structural layer 24 disposed on a surface 26 of substrate 22. A number of elements are formed in structural layer 24. In an embodiment, these elements include a moveable element, referred to herein as a proof mass 28, a frame structure 30, and anchors 32. Proof mass 28 is represented by downwardly and rightwardly directed wide hatching. Frame structure 30 is represented by upwardly and rightwardly directed narrow hatching, and anchors 32 are represented by a stippled pattern.

Frame structure 30 is laterally spaced apart from an outer periphery 34 of proof mass 28 and at least partially surrounds proof mass 28. Each of frame structure 30 and proof mass 28 are in spaced relationship above, i.e., suspended above, surface 26 of substrate 22. Compliant members 36 are coupled to each of proof mass 28 and frame structure 30 to retain an entirety of proof mass 28 suspended above surface 26 of substrate 22 without any direct coupling between, or structure directly interconnecting, proof mass 28 and substrate 22. In the illustrated embodiment, anchors 32 interconnect frame structure 30 with surface 26. Thus, both proof mass 28 and frame structure 30 are suspended above surface 26 of substrate 22, with the only attachment points being via anchors 32 (as shown in FIG. 2).

Proof mass 28 includes multiple electrodes, or fingers 38, extending outwardly from outer periphery 34 of proof mass 28. Fingers 38 may be any combination of sense and/or actuator electrodes. Multiple fingers 38 are arranged substantially parallel to surface 26 of substrate 22 and are oriented such that their length 40 is perpendicular to a sense direction 42 of MEMS device 20. In connection with the illustrated embodiment, sense direction 42 will be referred to hereinafter as an X-direction 42 which is perpendicular to a Y-direction 44. Both X-direction 42 and Y-direction 44 are substantially parallel to surface 26 of substrate 22.

Frame structure 30 also includes multiple electrodes, or fingers 46. Multiple fingers 46 extend inwardly from an inner periphery 48 of frame structure 30. Fingers 46 may also be any combination of sense and/or actuator electrodes. Like fingers 38, fingers 46 are arranged substantially parallel to surface 26 of substrate 22 and are oriented such that their length 50 is perpendicular to X-direction 42. In an embodiment, each of multiple fingers 38 extending from proof mass 28 may be disposed between a pair 52 of fingers 46. That is, each pair 52 of fingers 46 sandwich one of fingers 38, thus effectively forming a pair of capacitors.

In MEMS device 20, proof mass 28, frame structure 30, and fingers 38 and 46 are disposed such that the arrangement of these elements exhibits an axis of symmetry 54 that is perpendicular to X-direction 42. In this illustration, axis of symmetry 54 is co-located with section line 2-2. Such symmetry can allow for the effective elimination of cross-axis sensitivities so that in sensing acceleration in X-direction 42, MEMS device 20 senses only the components of acceleration that occur in X-direction 42. In an embodiment, anchors 32 are preferably positioned proximate axis of symmetry 54 of MEMS device 20.

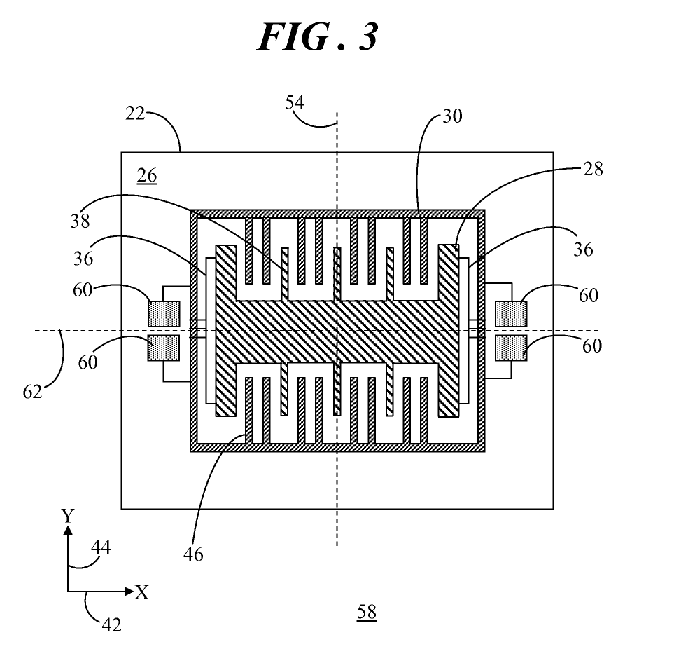

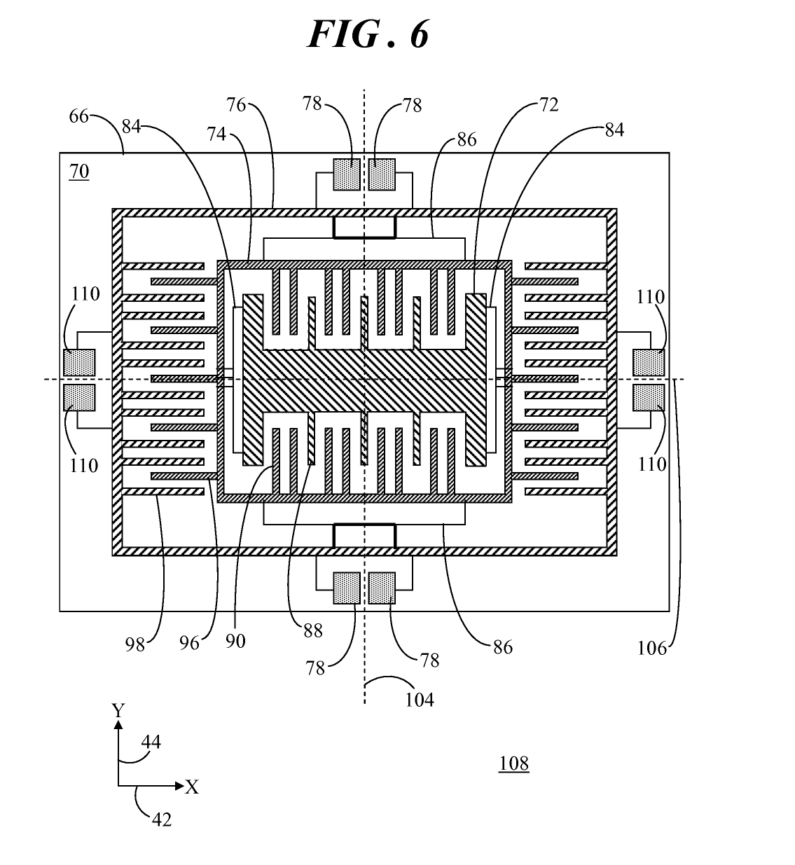

In general, anchors 32 suspend frame structure 30 above surface 26 of substrate 22, and retain frame structure 30 substantially immovable, or fixed, relative to the underlying substrate in X-direction 42. Additional compliant members, referred to herein as springs 56 may interconnect frame structure 30 with anchors 32. Springs 56 interconnecting anchors 32 and frame structure 30 are dimensioned such that they provide a sufficiently strong support to frame structure 30 while providing enough flexibility to shield frame structure 30 from any deformation of the underlying substrate 22. Each of anchors 32 is illustrated as being a single mechanical structure. Such a single mechanical structure may be divided into multiple components electrically by, for example, trench isolation, so that different potentials can be connected to and/or from frame structure 30. In an alternative embodiment, the anchors may also be mechanically split into multiple components, as shown in FIGS. 3 and 6, to achieve electrical isolation.

In the illustrated embodiment, MEMS device 20 may be an accelerometer having capacitive sensing capability. Accordingly, compliant members 36 suspend proof mass 28 over substrate 22 in a neutral position parallel to substrate 22. However, compliant members 36 function as springs whose one end is attached to frame structure 30 and whose opposing end is attached to proof mass 28 so as to enable proof mass 28 to move substantially parallel to surface 26 of substrate 22 in response to the selective application of a force, such as acceleration. By way of example, proof mass 28 of MEMS device 20 moves when MEMS device 20 experiences acceleration in X-direction 42. However, inner periphery 48 of frame structure 30 is greater than outer periphery 28 of proof mass 28 such that frame structure 30 is laterally spaced apart from proof mass 28 under nominal movement of proof mass 28.

Although proof mass 28 is mechanically one piece, it is electrically divided into multiple pieces by, for example, trench isolation in which interdevice electrical isolation is achieved by etching into the semiconductor material, i.e. proof mass 72. This electrical isolation allows a different electrical potential at each electrode. Likewise, frame structure 30 is also mechanically one piece, but it is also electrically divided into multiple pieces. The combination of the electrode fingers 38 in proof mass 28 and the electrode fingers 46 in frame structure 30 forms multiple capacitors. For example, since fingers 38 extend from proof mass 28, fingers 38 move in concert with proof mass 28. In contrast, fingers 46 extending inwardly from frame structure 30 are fixed, or immovable, in X-direction 42 relative to substrate 22. Accordingly, lateral movement of proof mass 28 in X-direction 42 may be detected by each pair 52 of fingers 46 arranged on opposing sides of fingers 38 extending from proof mass 28. That is, the lateral movement of proof mass 28 alters capacitance between the movable fingers 38 and the immovable fingers 46.

These varying capacitances between the fingers 38 and fingers 46 can be used to determine differential or relative capacitance indicative of the acceleration. The capacitances from these capacitors are directly fed into the accompanying signal processing circuitry (not shown). Accordingly, lateral movement in X-direction 42, detected by the variance of capacitances, can subsequently be converted via the signal processing circuitry into a signal having a parameter magnitude (e.g. voltage, current, frequency, etc.) that is dependent on the acceleration.

As discussed above, temperature variation and stress from packaging of a MEMS device, such as MEMS device 20, and/or its solder connection to an underlying printed circuit board can change the strain of substrate 22 causing offset shifts or displacements that lead to sensor inaccuracy. Furthermore, the strain profile of substrate 22 may be inconsistent across the plane of substrate 22. In MEMS device 20, the adverse affects of substrate deformation and an inconsistent strain profile are mitigated by the suspended configuration of proof mass 28, the suspended configuration of frame structure 30 from which immovable fingers 46 extend, by minimizing the interconnection of frame structure 22 to substrate 22, and by locating all connections, i.e., anchors 32, within close proximity of axis of symmetry 54. In particular, by coupling proof mass 28 to frame structure 30, proof mass 28 is isolated from direct contact with substrate 22. Therefore, any deformation of substrate 22 due to packaging stress will not be transmitted to proof mass 28 so that the relative gap between fingers 38 and 46 will remain the same regardless of this substrate deformation.

FIG. 3 shows a top view of a MEMS device 58 in accordance with another embodiment of the invention. MEMS device 58 is provided to demonstrate that anchors to the underlying substrate can be located at different regions. In accordance with the shading and/or hatching in FIGS. 1-2, the same shading and/or hatching is utilized in conjunction with FIG. 3 to distinguish the different elements produced within the structural layer of MEMS device 58.

MEMS device 58 includes substrate 22, proof mass 28 with its fingers 38, frame structure 30 with its fingers 46, and compliant members 36 coupled between proof mass 28 and frame structure 30. In this illustrative embodiment, frame structure 30 is interconnected with surface 26 of substrate 22 via anchors 60 that suspend frame structure 30 above surface 26 of substrate 22, and retain frame structure 30 substantially immovable, or fixed, relative to the underlying substrate 22 in X-direction 42.

In MEMS device 58, proof mass 28, frame structure 30, and their corresponding fingers 38 and 46 are disposed such that the arrangement of these elements exhibits both axis of symmetry 54 that is perpendicular to X-direction 42 and another axis of symmetry 62 that is parallel to X-direction 42. In the illustrative embodiment of MEMS device 58, anchors 60 can be positioned proximate axis of symmetry 62 in lieu of positioning anchors 32 proximate axis of symmetry 54 as discussed in connection with MEMS device 20. In practice, the location of anchors 32 on axis of symmetry 54 or alternatively anchors 60 on axis of symmetry 62 may be selected based upon which location offers the best reduction in offset caused by thermal mechanical stress and sensor robustness.

In the above presented examples, MEMS devices 20 and 58 may be single axis accelerometers for detection of lateral movement in X-direction 42. However, alternative embodiments may entail dual axis accelerometers (discussed below) or other MEMS sensing devices. In addition, both of MEMS devices 20 and 58 are discussed in terms of their symmetrical arrangement of elements. However, various other configurations for proof mass 28 and frame structure 30 without such symmetry may alternatively be utilized.

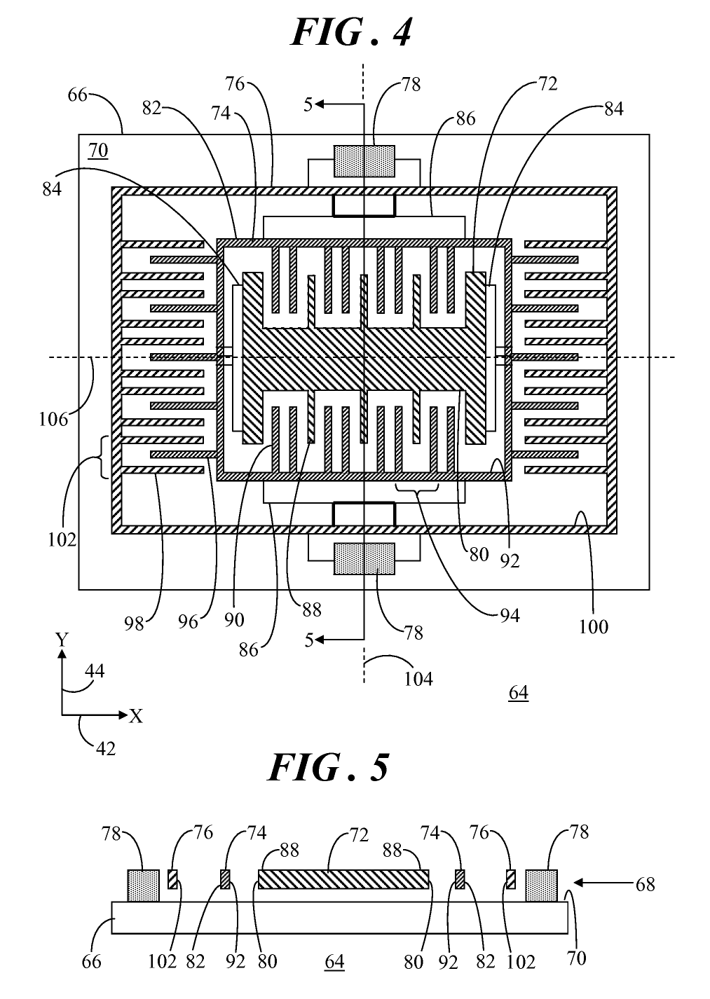

Referring to FIGS. 4 and 5, FIG. 4 shows a top view of a MEMS device 64 in accordance with another embodiment, and FIG. 5 shows a side view of MEMS device 64 along section line 5-5 of FIG. 4. MEMS device 64 is provided to illustrate a dual axis accelerometer configuration. FIGS. 4 and 5 are illustrated using various shading and/or hatching to distinguish the different elements produced within the structural layers of MEMS device 64, as will be discussed below.

MEMS device 64 includes a substrate 66 and a structural layer 68 disposed on a surface 70 of substrate 66. A number of elements are formed in structural layer 68. In an embodiment, these elements include a proof mass 72, an inner frame structure 74, an outer frame structure 76, and anchors 78. Proof mass 72 is represented by downwardly and rightwardly directed wide hatching. Inner frame structure 74 is represented by upwardly and rightwardly directed narrow hatching, outer frame structure 76 is represented by upwardly and rightwardly directed wide hatching, and anchors 78 are represented by a stippled pattern.

Inner frame structure 74 is laterally spaced apart from an outer periphery 80 of proof mass 72. Likewise, outer frame structure 76 is laterally spaced apart from an outer periphery 82 of inner frame structure 74. Each of proof mass 72, inner frame structure 74, and outer frame structure 76 are in spaced relationship above, i.e., suspended above, surface 70 of substrate 66. Compliant members 84 are coupled to each of proof mass 72 and inner frame structure 74 to retain an entirety of proof mass 72 suspended above surface 70 of substrate 66 in the absence of any direct coupling between, or structure directly interconnecting, proof mass 72 and substrate 66.

Similarly, compliant members 86 are coupled to each of inner frame structure 74 and outer frame structure 76 and retain an entirety of inner frame structure 74 in spaced relationship above, i.e., suspended above, surface 70 of substrate 66. Compliant members 86 are coupled to each of inner frame structure 74 and outer frame structure 76 to retain an entirety of proof mass inner frame structure 74 suspended above surface 70 of substrate 66 in the absence of any direct coupling between, or structure directly interconnecting, inner frame structure 74 and substrate 66. In the illustrated embodiment, anchors 78 interconnect outer frame structure 76 with surface 70. Thus, proof mass 72, inner frame structure 74, and outer frame structure 76 are all suspended above surface 70 of substrate 22, with the only attachment points being via anchors 78 (as shown in FIG. 2).

Proof mass 72 includes multiple electrodes, or fingers 88, extending outwardly from outer periphery 80 of proof mass 72. Fingers 88 are arranged substantially parallel to surface 70 of substrate 66 and are oriented such that their length is perpendicular to a sense direction, i.e., X-direction 42, of MEMS device 64. Inner frame structure 74 includes multiple electrodes, or fingers 90, that extend inwardly from an inner periphery 92 of inner frame structure 74. Fingers 90 are arranged substantially parallel to surface 70 of substrate 66 and are oriented such that their length is perpendicular to X-direction 42. In an embodiment, each of fingers 88 extending outwardly from proof mass 72 may be disposed between a pair 94 of fingers 90 extending inwardly from inner frame structure 74. Fingers 88 and 90 may be any combination of sense and/or actuator electrodes.

Inner frame structure 74 further includes multiple electrodes, or fingers 96, that extend outwardly from outer periphery 82 of inner frame structure 74. Fingers 96 are arranged substantially parallel to surface 70 of substrate 66 and are oriented such that their length is parallel to X-direction 42. Outer frame structure 76 includes multiple electrodes, or fingers 98, that extend inwardly from an inner periphery 100 of outer frame structure 76. Fingers 98 are arranged substantially parallel to surface 70 of substrate 66 and are oriented such that their length is also parallel to X-direction 42. In an embodiment, each of fingers 96 extending outwardly from inner frame structure 74 may be disposed between a pair 102 of fingers 98 extending inwardly from outer frame structure 76. Thus, fingers 96 and 98 are oriented perpendicular to fingers 88 and 90. Fingers 96 and 98 may be any combination of sense and/or actuator electrodes.

In MEMS device 64, proof mass 72, inner frame structure 74, and outer frame structure 76, and their corresponding fingers 88, 90, 96, and 98 are disposed such that the arrangement of these elements exhibits an axis of symmetry 104 that is perpendicular to X-direction 42. In this illustration, axis of symmetry 104 is co-located with section line 5-5. The elements of MEMS device 64 also exhibit an axis of symmetry 106 that is parallel to X-direction 42. Again, such symmetry can allow for the effective elimination of cross-axis sensitivities so that when sensing acceleration in X-direction 42, MEMS device 64 senses only the components of acceleration that occur in X-direction 42, and when sensing acceleration in Y-direction 44, MEMS device 64 senses only the components of acceleration that occur in Y-direction 44. In the illustrated embodiment, anchors 78 are positioned proximate axis of symmetry 104 of MEMS device 64. However, in an alternative embodiment, anchors 78 may be positioned proximate axis of symmetry 106 of MEMS device 64.

In general, anchors 78 suspend outer frame structure 76 above surface 70 of substrate 66, and retain outer frame structure 76 substantially immovable, or fixed, relative to the underlying substrate 66 in Y-direction 44. In addition, the interconnection of inner frame structure 74 with outer frame structure 76 via compliant members 86 retains inner frame structure 76 substantially immovable, or fixed, relative to the underlying substrate 66 in X-direction 42 but enables movement of inner frame structure 74 relative to the underlying substrate 66 in Y-direction 44.

In the illustrated embodiment, MEMS device 64 may be a dual axis accelerometer having capacitive sensing capability. Accordingly, compliant members 84 suspend proof mass 72 over substrate 66 in a neutral position parallel to surface 70 of substrate 66. However, compliant members 84 enable proof mass 72 to move substantially parallel to surface 70 of substrate 66 in response to the selective application of a force, such as acceleration. By way of example, proof mass 72 of MEMS device 64 moves in X-direction 42 when MEMS device 64 experiences acceleration in X-direction 42.

In addition, compliant members 86 suspend inner frame structure 74 and proof mass 72 over substrate 66 in a neutral position parallel to surface 70 of substrate 66. However, compliant members 86 enable the combination of inner frame structure 74 and proof mass 72 to move substantially parallel to surface 70 of substrate in response to the selective application of a force, such as acceleration. For example, inner frame structure 74 and proof mass 72 move together in Y-direction 44 when MEMS device 64 experiences acceleration in Y-direction.

Although proof mass 72 is mechanically one piece, it is electrically divided into multiple pieces through, for example, trench isolation, allowing different electrical potential in each electrode. Likewise, inner frame structure 74 is also mechanically one piece, but it is also electrically divided into multiple pieces. Furthermore, outer frame 76 is also mechanically one piece, but it is also electrically divided into multiple pieces through trench isolation. The combination of electrode fingers 88 extending outwardly from proof mass 72 and electrode fingers 90 extending inwardly from inner frame structure 74 form capacitors for sensing in X-direction 42. Likewise, the combination of electrode fingers 96 extending outwardly from inner frame structure 74 and electrode fingers 98 extending inwardly from outer frame structure 76 form capacitors for sensing in Y-direction 44.

For example, since fingers 88 extend outwardly from proof mass 72, fingers 88 move in concert with proof mass 72. In contrast, fingers 90 extending inwardly from inner frame structure 74 are fixed, or immovable, in X-direction 42 relative to substrate 66. Accordingly, lateral movement of proof mass 72 in X-direction 42 may be detected by each pair 94 of fingers 90 arranged on opposing sides of fingers 88 extending from proof mass 72. That is, the lateral movement of proof mass 72 in X-direction 42 alters capacitances between the movable fingers 88 and the immovable fingers 90. These varying capacitances between the movable fingers 88 and immovable fingers 90 can be used to determine differential or relative capacitance indicative of the acceleration in X-direction 42.

In addition, since fingers 96 extend outwardly from inner frame structure 74 and are lengthwise oriented parallel with X-direction 42 and since fingers 98 extend inwardly from outer frame structure 76 and are also lengthwise oriented parallel with X-direction 42, capacitances between fingers 96 and 98 will be unvarying in response to acceleration in X-direction 42.

However, since fingers 96 extend outwardly from inner frame structure 74 and compliant members 86 interconnect inner frame structure 74 with outer frame structure 76, fingers 96 are able to move in concert with inner frame structure 74 in Y-direction 44. It should be recalled that fingers 98 extending inwardly from outer frame structure 76 are fixed, or immovable, in Y-direction 44 relative to substrate 66. Accordingly, lateral movement of inner frame structure 74 and proof mass 72 in Y-direction 44 may be detected by each pair 102 of fingers 98 arranged on opposing sides of fingers 96. That is, the lateral movement of inner frame structure 74 and proof mass 72 in Y-direction 44 alters capacitances between the movable fingers 96 and the immovable fingers 98. These varying capacitances between the movable fingers 96 and immovable fingers 98 can be used to determine differential or relative capacitance indicative of the acceleration in Y-direction 44. Of course, since fingers 88 extend outwardly from proof mass 72 and are lengthwise oriented parallel to Y-direction 44 and since fingers 90 extend inwardly from inner frame structure 74 and are also lengthwise oriented parallel to Y-direction 44, capacitances between fingers 88 and 90 will be unvarying in response to acceleration in Y-direction 44. The capacitances from these capacitors can be directly fed into the accompanying signal processing circuitry (not shown).

In MEMS device 64, the adverse affects of an inconsistent strain profile are mitigated by the suspended configuration of proof mass 72, the suspended configuration of inner and outer frame structures 74 and 76, by minimizing the interconnection of outer frame structure 76 to substrate 66, and by locating all connections, i.e., anchors 78, within close proximity of axis of symmetry 104.

FIG. 6 shows a top view of a MEMS device 108 in accordance with yet another embodiment of the invention. MEMS device 108 is provided to demonstrate that additional anchors to the underlying substrate may be implemented. In accordance with the shading and/or hatching in FIGS. 4-5, the same shading and/or hatching is utilized in conjunction with FIG. 6 to distinguish the different elements produced within the structural layer of MEMS device 108.

MEMS device 108 includes substrate 66, proof mass proof mass 72 with its fingers 88, inner frame structure 74 with its inwardly extending fingers 90 and its outwardly extending fingers 96, and outer frame structure 76 with its inwardly extending fingers 98. MEMS device 108 also includes compliant members 84 coupled between proof mass 72 and inner frame structure 74, as well as compliant members 86 coupled between inner frame structure 74 and outer frame structure 76.

In this illustrative embodiment, outer frame structure 76 is interconnected with surface 70 of substrate 66 via anchors 78 positioned proximate axis of symmetry 104. In addition, outer frame structure 76 is interconnected with surface 70 of substrate 66 via anchors 110 positioned proximate axis of symmetry 106. Anchors 78 and 110 function cooperatively to suspend outer frame structure 76 above surface 70 of substrate 66. Various dual axis configurations, may include only anchors 78 on axis of symmetry 104, only anchors 110 on axis of symmetry 106, or both anchors 78 and 110 on corresponding axes of symmetry 104 and 106. The selection and positioning of only anchors 78, only anchors 110, or both anchors 78 and 110 in a single MEMS device, such as MEMS device 108, may be selected based upon which locations offer the best reduction in offset caused by thermal mechanical stress and sensor robustness.

Embodiments described herein comprise MEMS devices in which the MEMS devices are largely stress isolated from the underlying substrate. This isolation is achieved by the suspended configuration of the proof mass, the suspended configuration of one or more frame structures, by minimizing the interconnection of the one or more frame structures to the underlying substrate, by providing the flexibility of the connections, and/or by locating all connections, i.e., anchors, within close proximity of an axis of symmetry of the MEMS device. Accordingly, the movable and fixed electrode elements are not in direct contact with the substrate. The minimized quantity of anchors reduces the adverse effects of inconsistencies and irregularities of strain across the plane of the substrate. Thus, such a MEMS device is less susceptible to mismatch, or offset, caused by thermal mechanical stress, and can be readily implemented as a low cost, compact, single die transducer utilizing conventional manufacturing processes.

Although the preferred embodiments of the invention have been illustrated and described in detail, it will be readily apparent to those skilled in the art that various modifications may be made therein without departing from the spirit of the invention or from the scope of the appended claims. For example, the MEMS device may be adapted to include a different number and location of anchors. In addition, the proof mass, frame structures, compliant members, and fixed and movable fingers can take on various other shapes and sizes then those which are shown.

What is claimed is:

1. A microelectromechanical systems (MEMS) device comprising:
a substrate;
a proof mass suspended above a surface of said substrate, said proof mass including a first finger extending outwardly from an outer periphery of said proof mass;
a frame structure laterally spaced apart from said outer periphery of said proof mass, said frame structure including second fingers extending inwardly from an inner periphery of said frame structure, said first finger being disposed between a pair of said second fingers;
at least one compliant member coupled to each of said proof mass and said frame structure to retain said proof mass suspended above said surface of said substrate, said at least one compliant member enabling said proof mass to move substantially parallel to said surface of said substrate in a sense direction in response to a force in said sense direction so that said first finger moves relative to said second fingers; and
at least one anchor configured retain said frame structure suspended above said surface of said substrate.

2. A MEMS device as claimed in claim 1 wherein said at least one compliant member retains said proof mass suspended above said surface of said substrate without a direct coupling between said proof mass and said substrate.

3. A MEMS device as claimed in claim 1 wherein said at least one anchor retains said frame structure suspended above said surface of said substrate without a direct coupling between said frame structure and said substrate.

4. A MEMS device as claimed in claim 1 wherein said at least one anchor retains said frame structure substantially immovable relative to said substrate in said sense direction.

5. A MEMS device as claimed in claim 1 wherein said at least one anchor is positioned proximate an axis of symmetry of said MEMS device.

6. A MEMS device as claimed in claim 1 wherein:
said proof mass further includes multiple first fingers extending outwardly from said outer periphery of said proof mass and lengthwise oriented perpendicular to said sense direction, said first finger being one of said multiple first fingers; and
said frame structure further includes multiple pairs of said second fingers extending inwardly from said inner periphery of said frame structure and lengthwise oriented perpendicular to said sense direction, said pair of said second fingers being one of said multiple pairs of said second fingers, and one each of said multiple first fingers is disposed between one each of said multiple pairs of said second fingers.

7. A MEMS device as claimed in claim 1 wherein said inner periphery of said frame structure is greater than said outer periphery of said proof mass such that said frame structure is laterally spaced apart from said proof mass under nominal movement of said proof mass.

8. A MEMS device as claimed in claim 1 wherein said frame structure is a first frame structure, said sense direction is a first sense direction, said at least one compliant member is a first compliant member, and said MEMS device further comprises:
a second frame structure laterally spaced apart from a second outer periphery of said first frame structure, said second frame structure being suspended above said surface of said substrate; and
a second compliant member coupled to each of said first and second frame structures, said second compliant member enabling said first frame structure to move substantially parallel to said surface of said substrate in a second sense direction in response to said force in said second sense direction, said second sense direction being perpendicular to said first sense direction.

9. A MEMS device as claimed in claim 8 wherein said at least one anchor is coupled between said second frame structure and said substrate.

10. A MEMS device as claimed in claim 9 wherein said at least one anchor retains said second frame structure substantially immovable relative to said substrate in said second sense direction.

11. A MEMS device as claimed in claim 9 wherein said first frame structure is suspended above said surface of said substrate without a direct coupling between said first frame structure and said substrate.

12. A MEMS device as claimed in claim 8 wherein:
said first frame structure includes a third finger extending outwardly from said second outer periphery and lengthwise oriented perpendicular to said second sense direction; and
said second frame structure includes fourth fingers extending inwardly from a second inner periphery of said second frame structure and lengthwise oriented perpendicular to said second sense direction, said third finger being disposed between a pair of said fourth fingers, wherein movement of said first frame structure in said second sense direction causes said third finger to move relative to said pair of said fourth fingers.

13. A MEMS device as claimed in claim 1 wherein:
said at least one anchor is positioned proximate a first axis of symmetry of said MEMS device; and
said MEMS device further comprises a second anchor configured to retain said first frame structure suspended above said surface of said substrate, said second anchor being positioned proximate a second axis of symmetry of said MEMS device.

14. A microelectromechanical systems (MEMS) device comprising:
a substrate;
a proof mass suspended above a surface of said substrate, said proof mass including a first finger extending outwardly from an outer periphery of said proof mass;
a frame structure laterally spaced apart from said outer periphery of said proof mass, said frame structure including second fingers extending inwardly from an inner periphery of said frame structure, said first finger being disposed between a pair of said second fingers;
at least one compliant member coupled to each of said proof mass and said frame structure to retain said proof mass suspended above said surface of said substrate without a direct coupling between said proof mass and said substrate, said at least one compliant member enabling said proof mass to move substantially parallel to said surface of said substrate in a sense direction in response to a force in said sense direction so that said first finger moves relative to said pair of said second fingers; and
at least one anchor configured to retain said frame structure suspended above said surface of said substrate, said at least one anchor retaining said frame structure substantially immovable relative to said substrate in said sense direction.

15. A MEMS device as claimed in claim 14 wherein said frame structure is a first frame structure, said sense direction is a first sense direction, said at least one compliant member is a first compliant member, and said MEMS device further comprises:
a second frame structure laterally spaced apart from a second outer periphery of said first frame structure, said second frame structure being suspended above said surface of said substrate; and
a second compliant member coupled to each of said first and second frame structures, said second compliant member enabling said first frame structure to move substantially parallel to said surface of said substrate in a second sense direction in response to said force in said second sense direction, said second sense direction being perpendicular to said first sense direction, wherein said at least one anchor is coupled between said second frame structure and said substrate.

16. A MEMS device as claimed in claim 15 wherein said at least one anchor retains said second frame structure substantially immovable relative to said substrate in said second sense direction.

17. A MEMS device as claimed in claim 15 wherein said first frame structure is suspended above said surface of said substrate without a direct coupling between said first frame structure and said substrate.

18. A MEMS device as claimed in claim 15 wherein:
said first frame structure includes a third finger extending outwardly from a second outer periphery of said first frame structure and lengthwise oriented perpendicular to said second sense direction; and
said second frame structure includes fourth fingers extending inwardly from a second inner periphery of said second frame structure and lengthwise oriented perpendicular to said second sense direction, said third finger being disposed between a pair of said fourth fingers, wherein movement of said first frame structure in said second sense direction causes said third finger to move relative to said pair of said fourth fingers.

19. A microelectromechanical systems (MEMS) device comprising:
a substrate;
a proof mass suspended above a surface of said substrate, said proof mass including a first finger extending outwardly from an outer periphery of said proof mass;
a frame structure laterally spaced apart from said outer periphery of said proof mass, said frame structure including second fingers extending inwardly from an inner periphery of said frame structure, said first finger being disposed between a pair of said second fingers;
at least one compliant member coupled to each of said proof mass and said frame structure to retain said proof mass suspended above said surface of said substrate, said at least one compliant member enabling said proof mass to move substantially parallel to said surface of said substrate in a sense direction in response to a force in said sense direction so that said first finger moves relative to said pair of said second fingers; and
at least one anchor configured to retain said frame structure suspended above said surface of said substrate, said at least one anchor is positioned proximate an axis of symmetry of said MEMS device, and said at least one anchor retaining said frame structure substantially immovable relative to said substrate in said sense direction.

20. A MEMS device as claimed in claim 19 wherein said at least one compliant member retains said proof mass suspended above said surface of said substrate without a direct coupling between said proof mass and said substrate.
